(19) United States
(12) Patent Application Publication
(10) Pub. No.: US 2026/0218676 A1
(43) Pub. Date: Jul. 30, 2026

(54) GUIDING SYSTEMS FOR WIND TURBINE BLADE COMPONENTS

(71) Applicants: LM Wind Power A/S, Kolding (DK); LM Wind Power Blades (Qinhuangdao) Co. Ltd., Heibei, Qinhuangdao (CN)

(72) Inventors: Adam Giedrojc, Goleniow (PL); Wei Zheng, Heibei, Qinhuangdao (CN)

(21) Appl. No.: 19/148,136

(22) PCT Filed: Jan. 16, 2023
(86) PCT No.: PCT/CN2023/072354

§ 371 Date: Jul. 15, 2025

(51) Int. Cl. F03D 1/06; F03D 13/10

(52) U.S. Cl. CPC F03D 1/0675; F03D 13/10; F05B 2240/30

(57) ABSTRACT

In a first aspect, a guiding system for a wind turbine blade component is provided. The guiding system comprises a guide member configured to guide the wind turbine blade component relative to an inner surface of the blade shell. The guide member is removably attached to a base which is configured to be connected to the inner surface of the blade shell. In a further aspect, a method for mounting a wind turbine blade component within a wind turbine blade is provided. In a further aspect, a wind turbine blade is provided as well.

The present disclosure relates to guiding systems for wind turbine blade components, wind turbine blades, and methods for mounting wind turbine blade components within a wind turbine blade.

### BACKGROUND

Modern wind turbines are commonly used to supply electricity into the electrical grid. Wind turbines of this kind generally comprise a rotor with a rotor hub and a plurality of blades. The rotor is set into rotation under the influence of the wind on the blades. The rotation of the rotor shaft drives the generator rotor either directly (“directly driven”) or through the use of a gearbox. The gearbox (if present), the generator and other systems are usually mounted in a nacelle on top of a wind turbine tower.

Wind turbine blades have a root portion to attach the rotor hub and a tip portion at an opposite end. The root portion of the wind turbine blade usually has a generally round cross-section. Some other regions such as a profiled or an airfoil portion that is furthest away from the rotor hub, have a cross-section with an aerodynamic profile.

Wind turbine blades comprise a blade shell that may define at least one blade cavity internal to the wind turbine blade. Wind turbine blade components such as electrical components, sensors, or reinforcing elements can be installed inside the blade cavity, for instance, connected to an inner surface of the blade shell.

Some guiding devices may be used to prevent the wind turbine blade component is displaced from a predetermined position relative to the inner surface of the blade shell during the manufacturing process of a wind turbine blade. The guiding devices are usually attached to the inner surface of the blade shell.

When the blade shell comprises two half blade shell parts, the two half blade shell parts are joined together to form the wind turbine blade. The wind turbine blade component, e.g. a load-carrying structure, may be attached to one of the half blade shell parts before the two half blade shell parts are joined. During the process of joining the blade shell parts, the load-carrying structure, e.g. a shear web, may be deviated or misaligned from its predetermined position. The load-carrying structure may be unintentionally displaced relative to one of the half blade shells while the two half blade shell parts are joined together.

The guiding devices may guide or align the load carrying structure to reach the predetermined position while the two half blade shell parts are brought together and may keep the load-carrying structure in this predetermined position after joining the two blade shell parts. The guiding devices are usually glued to the inner surface of the blade shell before joining the two blade shell parts.

These guiding devices may be left inside the wind turbine blade, however, the mass of the wind turbine blade may be unnecessarily increased. Furthermore, the guiding devices bonded to the blade shell may be accidentally dislodged and damage the structure of the wind turbine blade when the wind turbine blade is in operation.

Accordingly, these guiding devices are generally removed after guiding or aligning the load-carrying structure inside the wind turbine blade and joining the two blade shell parts. These guiding devices are usually detached from the inner surface of the blade shell by an operator. Consequently, an operator must access the position of these guiding devices. However, some guiding devices may be difficult to access. For example, guiding devices glued to the inner surface of the blade shell arranged in the third part of the blade closest to the blade tip may be difficult to access and, consequently, to remove. Furthermore, accessing the reduced space of some zones inside the wind turbine blade may increase the risk of the operator hitting the blade shell. Furthermore, the guiding devices may protrude from the inner surface of the blade shell, and this may represent a safety hazard for the staff. Staff or operators working inside the blade cavity may thus be injured by the protruding guiding devices. Moreover, staff cannot access all the regions of the blade cavity of the wind turbine blade for safety reasons and/or because available space inside the wind turbine blade may be significantly reduced. This may imply that some guiding devices cannot be removed.

Removing the guiding device from the inner surface of the blade shell may also involve the use of a relatively high force and may require specific skills of the operator. This may generally involve a relatively long manufacturing time.

The guiding devices may also be damaged during their removal, e.g by the use of some tools. Therefore, the removed guiding devices cannot be reused. This may suppose an extra cost.

Furthermore, the inner surface of the blade shell may be damaged after the glued guiding device is removed. Grinding and/or sandblasting the inner surface of the blade shell may be required. This task may represent a safety risk for the staff and an increase in the manufacturing time, particularly in the post moulding stage.

Document EP 4 039 453 A1 discloses a guide member for guiding a shear web of a wind turbine blade.

The present disclosure provides examples of systems and methods that at least partially resolve some of the aforementioned disadvantages.

### SUMMARY

In a first aspect, a guiding system for a wind turbine blade component is provided. The guiding system comprises a guide member to guide the wind turbine blade component relative to an inner surface of a blade shell. The guiding system further comprises a base removably attached to the guide member, wherein the base is to be connected to the inner surface of the blade shell.

According to this aspect, the guiding system may guide or align the wind turbine blade component relative to a portion of the blade shell. The wind turbine blade component may thus be properly positioned relative to the blade shell when the wind turbine blade is manufactured, for example during the forming the blade shell.

If the blade shell is formed by joining together two wind turbine blade half shell parts, the wind turbine blade component may be properly positioned in a predetermined position relative to the blade shell after the wind turbine blade half shell parts are joined together.

As the guide member is removably attached to the base, the guide member may be easily removed from the base. The guide member may be detached from the base without getting damaged after the removal. So, the guide member may be reused for manufacturing other wind turbine blades. This may signify a cost saving and avoid a waste of material.

Furthermore, the risk of damaging the inner surface of the blade shell after the removal of the guide member may be minimized. Grinding or sandblasting the inner surface of the blade shell after removing the guide member is thus avoided. So, the manufacturing cycle time may be reduced.

When the guide member is installed it protrudes from the inner surface of the blade shell. If the guide member is removed from the base, the risk of staff being struck by a protruding guide member may be minimized. Operations performed inside the wind turbine blade may thus be more safely performed.

In a further aspect, a method for mounting a wind turbine blade component within a wind turbine blade is provided. The method comprises connecting a base of a guiding system to an inner surface of a blade shell. The method comprises guiding the wind turbine blade component through a guiding region inside the wind turbine blade with a guide member of the guiding system, wherein the guide member is removably attached to the base. In addition, the method comprises removing the guide member from the base.

In a further aspect, a wind turbine blade is provided. The wind turbine blade comprises a blade shell and a wind turbine blade component. The wind turbine blade comprises a base of a guiding system connected to an inner surface of the blade shell. The base is configured to be removably attached to a guide member of the guiding system.

Advantages derived from these aspects may be similar to those mentioned regarding the previous aspects.

### BRIEF DESCRIPTION OF THE DRAWINGS

Non-limiting examples of the present disclosure will be described in the following, with reference to the appended drawings, in which:

FIG. 1 illustrates a perspective view of a wind turbine according to one example;

FIG. 2 illustrates a simplified, internal view of a nacelle of a wind turbine according to one example;

FIG. 3 shows a perspective view of a wind turbine blade according to one example;

FIG. 4A shows a cross-sectional view of a wind turbine blade according to one example;

FIG. 4B shows a cross-sectional view of a wind turbine blade according to a further example;

FIG. 5 schematically illustrates a perspective view of a guiding system of the present disclosure mounted on a wind turbine blade;

FIG. 6 schematically illustrates a perspective view of a guiding system according to one example of the present disclosure;

FIG. 7 shows a perspective view of a guide member of the guiding system according to one example of the present disclosure;

FIG. 8 shows a perspective view of a base of the guiding system according to one example of the present disclosure;

FIG. 9 shows a cross-sectional view of the base of FIG. 8;

FIG. 10 shows a perspective view of a base of the guiding system according to a further example of the present disclosure;

FIG. 11 shows a front view of the base of FIG. 10;

FIG. 12 shows a perspective view of a pulling member attached to a guide member according to one example;

FIG. 13 is a block diagram of a method for mounting a wind turbine blade component within a wind turbine blade according to an example of the present disclosure;

FIG. 14A schematically illustrates a perspective view of a plurality of guiding systems mounted on a blade shell according to one example;

FIG. 14B schematically illustrates a perspective view of the plurality of mounted guiding systems of FIG. 14A and a wind turbine blade component according to one example;

FIG. 14C schematically illustrates a perspective view of the plurality of mounted guiding systems of FIG. 14B without the guide members according to one example;

FIG. 15 schematically illustrates a cross-sectional view of two wind turbine half blade shell parts before being joined together;

FIG. 16 schematically illustrates a cross-sectional view of two wind turbine half shell parts after being joined together;

FIG. 17 schematically illustrates a plurality of guiding systems mounted on a blade shell according to one example; and

FIG. 18 schematically illustrates a plurality of guiding systems mounted in a zig-zag configuration on a blade shell according to one example.

### DETAILED DESCRIPTION OF EXAMPLES

In these figures the same reference signs have been used to designate matching elements.

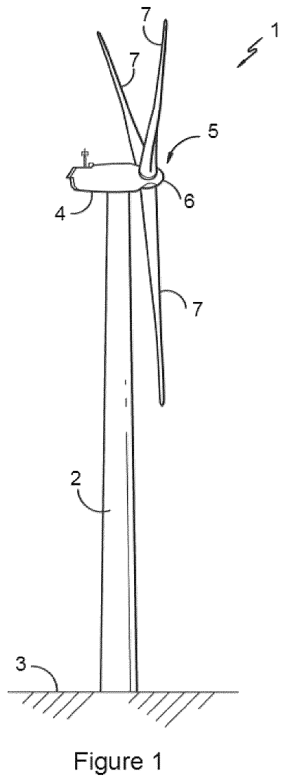

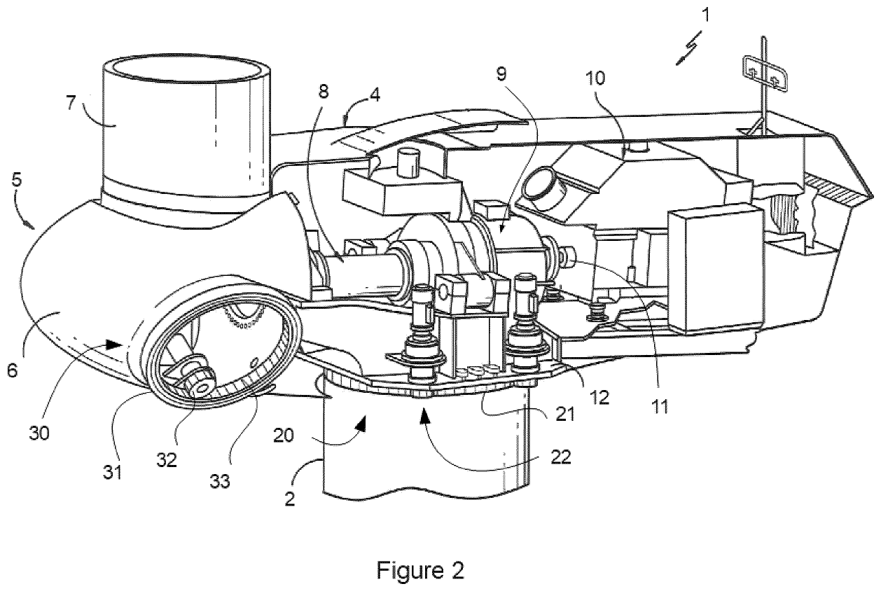

FIG. 1 illustrates a perspective view of one example of a wind turbine 1. As shown, the wind turbine 1 includes a tower 2 extending from a support surface 3, a nacelle 4 mounted on the tower 2, and a rotor 5 coupled to the nacelle 4. The rotor 5 includes a rotatable hub 6 and at least one wind turbine blade 7 coupled to and extending outwardly from the rotor hub 6. For example, in the illustrated example, the rotor 5 includes three wind turbine blades 7. However, in an alternative embodiment, the rotor 5 may include more or less than three wind turbine blades 7. Each wind turbine blade 7 may be spaced from the rotor hub 6 to facilitate rotating the rotor 5 to enable kinetic energy to be transferred from the wind into usable mechanical energy, and subsequently, electrical energy. For instance, the rotor hub 6 may be rotatably coupled to an electric generator 10 (FIG. 2) positioned within the nacelle 4 or forming part of the nacelle to permit electrical energy to be produced.

FIG. 2 illustrates a simplified, internal view of one example of the nacelle 4 of the wind turbine 1 of the FIG. 1. As shown, the electric generator 10 may be disposed within the nacelle 4. In general, the generator 10 may be coupled to the rotor 5 of the wind turbine 1 for generating electrical power from the rotational energy generated by the rotor 5. For example, the rotor 5 may include a main rotor shaft 8 coupled to the rotor hub 6 for rotation therewith. The generator 10 may then be coupled to the rotor shaft 8 such that the rotation of the rotor shaft 8 drives the generator 10. For instance, in this figure, the generator 10 includes a generator shaft 11 rotatably coupled to the rotor shaft 8 through a gearbox 9. In other examples, the generator may be directly coupled to the rotor hub or to the rotor shaft.

It should be appreciated that the rotor shaft 8, gearbox 9, and generator 10 may generally be supported within the nacelle 4 by a bedplate or a support frame 12 positioned atop the tower 2.

The nacelle 4 is rotatably coupled to the tower 2 through a yaw system 20. The yaw system comprises a yaw bearing (not visible in FIG. 2) having two bearing components configured to rotate with respect to the other. The tower 2 is coupled to one of the bearing components and the bedplate or support frame 12 of the nacelle 4 is coupled to the other bearing component. The yaw system 20 comprises a yaw annular gear 21 and a plurality of yaw drives 22 with a motor, a gearbox and a pinion for meshing with the annular gear for rotating one of the bearing components with respect to the other.

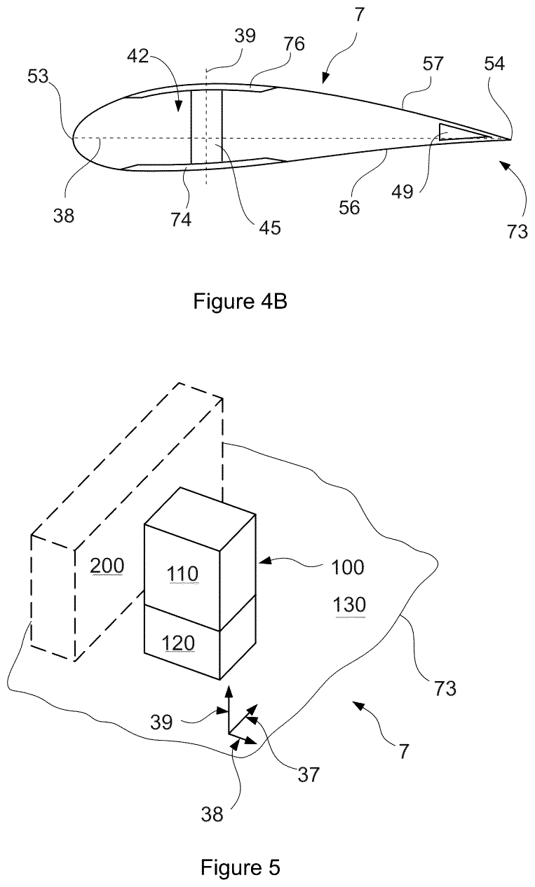

Wind turbine blades 7 are coupled to the rotor hub 6 with a pitch bearing 31 in between the wind turbine blade 7 and the rotor hub 6. The pitch bearing 31 comprises an inner ring and an outer ring (shown in FIG. 4). A wind turbine blade may be attached either to the inner bearing ring or to the outer bearing ring, whereas the hub is connected to the other. A wind turbine blade 7 may perform a relative rotational movement with respect to the rotor hub 6 when a pitch system 30 is actuated. The inner bearing ring may therefore perform a rotational movement with respect to the outer bearing ring. The pitch system 30 of FIG. 2 comprises a pinion 32 that meshes with a pitch annular gear 33 provided on the inner bearing ring to set the wind turbine blade into rotation.

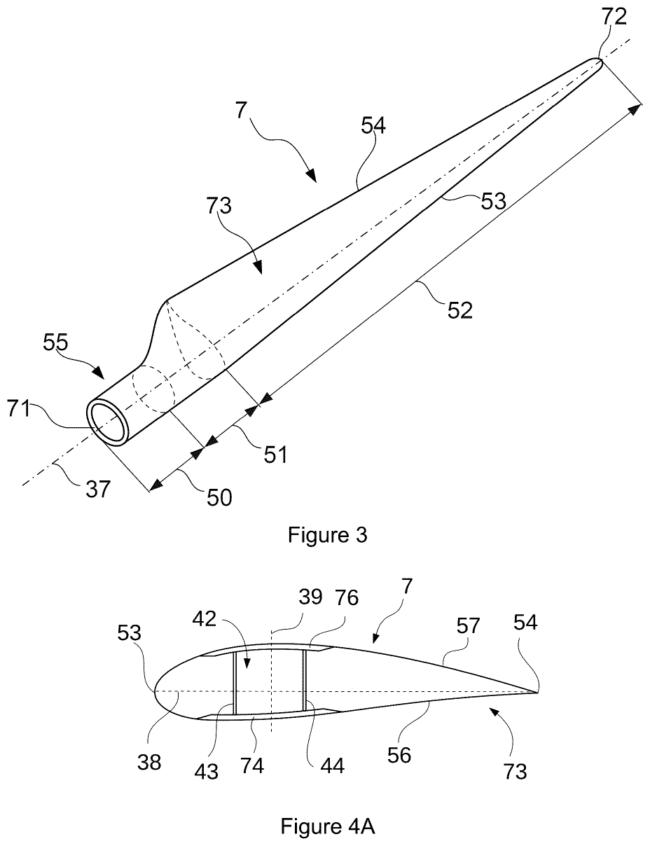

FIG. 3 illustrates an example of a wind turbine blade 7. The wind turbine blade 7 extends in a longitudinal direction or spanwise direction 37 from a blade root end 71 to a blade tip end 72. The wind turbine blade 7 comprises a blade root region or portion 50 closest to the rotor hub, a profiled or an airfoil portion 52 furthest away from the rotor hub and a transition portion 51 between the blade root portion 50 and the airfoil portion 52. The wind turbine blade 7 comprises a leading edge 53 facing the direction of rotation of the wind turbine blade 7 when mounted on the rotor hub, and a trailing edge 54 facing the opposite direction of the leading edge 53.

The airfoil portion 52 has a shape designed to generate lift, whereas the blade root portion 50 has a circular or elliptical cross-section for structural considerations and for easy mounting the blade to the rotor hub. The diameter or the chord of the blade root portion 50 may be constant along the entire blade root portion 50. The blade root portion 50 comprises a blade root attachment portion 55 configured to attach the blade root portion to the rotor hub. At the transition portion 51, the profile gradually changes from the circular or elliptical cross-section of the blade root portion 50 to the airfoil profile of the airfoil portion 52.

The wind turbine blade 7 comprises a blade shell 73. The blade shell may comprise two blade shell parts, for example, a pressure side blade shell and a suction side blade shell. The pressure side blade shell may be joined, e.g. glued or bonded, to the suction side blade shell along joining lines along the leading edge 53 and the trailing edge 54. The blade shell 73 comprises an outer side or surface that defines the external shape of the blade, e.g. the outer shape at the blade root portion and the outer shape at the airfoil portion. The blade shell 73 also comprises an inner side or surface that defines the internal volume or blade cavity of the blade and faces a load-carrying structure (not shown). The blade shell 73 may be made of fiber-reinforced polymer, e.g. glass-fiber and/or carbon fiber.

FIGS. 4A and 4B respectively show cross-sectional views of the wind turbine blade according to different examples of the present disclosure. A suction side 57 or downwind side and a pressure side 56 or upwind side extend from the leading edge 53 to the trailing edge 54. The wind turbine blade 7 further comprises an edgewise direction or chord line 38 between the leading edge 53 and the trailing edge 54. A flapwise direction 39 is substantially perpendicular to the edgewise direction 38. A blade cavity 42 is defined internal the wind turbine blade by the blade shell 73. The blade cavity 42 may extend throughout a length along the spanwise direction.

The wind turbine blade 7 comprises a blade structure that provides stiffness to the wind turbine blade. The blade structures of these examples comprise the blade shell 73, load-carrying structures 43, 44, 45, and reinforcing element 49. Particularly, the example of FIG. 4A comprises two load-carrying structures 43, 44 such as shear webs, particularly a leading edge shear web 43 and a trailing edge shear web 44.

The load-carrying structure of FIG. 4A comprises a pressure side spar cap 74 arranged at the pressure side 56 and a suction side spar cap 76 at the suction side 57. In some examples, the shear webs 43 and 44 could be a spar box with spar sides, such as a trailing edge spar side and a leading edge spar side.

The example of FIG. 4B comprises a load-carrying structure such as a shear web 45 and a reinforcing element 49 such as trailing edge reinforcement.

The load-carrying structures of these figures may be examples of wind turbine blade components according to the present disclosure. The shear webs 43, 44 and/or 45 and/or the reinforcing element 49 may thus be examples of wind turbine blade components.

FIG. 5 schematically illustrates a perspective view of a guiding system 100 of the present disclosure mounted on a wind turbine blade 7. The guiding system 100 comprises a guide member 110 to guide the wind turbine blade component 200 relative to an inner surface 130 of the blade shell 73. It can be also seen that the guiding system 100 comprises a base 120 removably attached to the guide member 110. The base is configured to be connected to the inner surface 130 of the blade shell 73. In FIG. 5, the wind turbine blade component 200 has been illustrated in dotted lines for the sake of clarity.

The wind turbine blade component 200 to be guided may comprise an electrical component, a load-carrying structure, a reinforcing element, a wire, a sensor, a lightning protection system, and/or the like. Examples of load-carrying structures may comprise a shear web, or a box beam structure. A leading edge reinforcement and a trailing edge reinforcement may be examples of reinforcing elements.

For example, the wind turbine blade component 200 may comprise a shear web. The shear web may be an example of a load-carrying structure.

In the example of FIG. 5, the guiding system 100 comprises a width extending along a lateral axis, a length extending along a longitudinal axis, and a height extending along a vertical axis of the guiding system 100. However, in other examples, the width may extend along a longitudinal axis and the length may extend along a lateral axis.

When the guiding system is connected to the wind turbine blade 7, the longitudinal axis of the guiding system 100 may extend substantially parallel to the chordwise direction 38, the lateral axis substantially parallel to the spanwise direction 37, and the vertical axis substantially parallel to the flapwise direction 39.

The guiding system 100 may thus be used to guide a movement of the wind turbine blade component 200 relative to the inner surface 130 of the blade shell 73. For example, the guiding system 100 may restrict a movement of the wind turbine blade component 200 in a direction parallel to the chordwise direction 38. Movements of the wind turbine blade component 200 along the spanwise direction 37 and/or the flapwise direction 39 within the wind turbine blade may thus be guided to reach a predetermined position.

As explained before, the guide member 110 is removably attached to the base 120. For example, the base 120 may comprise one or more base engaging portions to engage a corresponding guide member engaging portion for removably attaching the guide member 110 to the base 120.

In some examples, the guide member 110 and the base 120 may comprise a plastic material. The guide member 110 and the base 120 may be extruded or injection-moulded polymer parts. In some examples, the guide member 110 and the base 120 may be made from different materials.

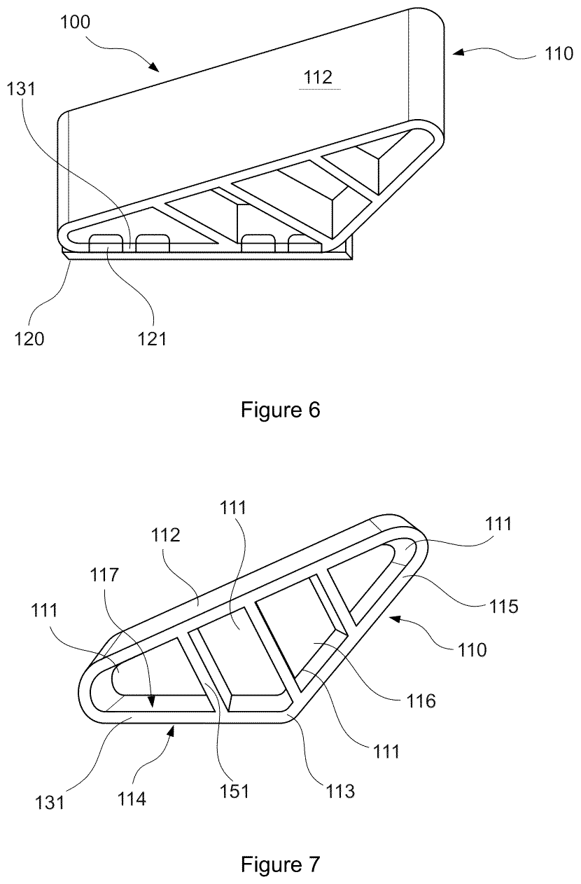

FIG. 6 schematically illustrates a perspective view of a guiding system 100 according to one example of the present disclosure. In the example of FIG. 6, the base 120 comprises base engaging portions 121 configured to engage a corresponding guide member engaging portion 131 for removably attaching the guide member 110 to the base 120. In some examples, at least one of the base engaging portions 121 and the corresponding guide member engaging portion 131 may comprise a snap-fit joint. However, in other examples, at least one of the base engaging portion 121 and the corresponding guide member engaging portion 131 comprise an alternative type of joint.

In examples, one of the base engaging portions 121 and the corresponding guide member engaging portion 131 may comprise a protrusion and the other one may comprise a depression to mate the protrusion. In FIG. 6, the base engaging portion 121 comprises the protrusion and the guide member engaging portion 131 comprises the depression. In other examples, the base engaging portion 121 may comprise the depression and the guide member engaging portion 131 may comprise the protrusion.

In this example, the protrusion of the base engaging portion 121 extends along the vertical axis. Accordingly, when the base 120 is mounted on the wind turbine blade 7 and the guide member 110 is coupled to the base 120, the protrusion extends substantially parallel to the flapwise direction.

In some examples, the base 120 comprises a plurality of base engaging portions 121. The plurality of base engaging portions 121 may comprise at least one base engaging portion 121 having a protrusion and at least one base engaging portion 121 having a depression. This depression may mate a corresponding protrusion of the guide member engaging portion 131. The guide member 110 may comprise a plurality of guide member engaging portions 131. The plurality of guide member engaging portions 131 may comprise at least one guide member engaging portion 131 having a protrusion and at least one guide member engaging portion 131 having a depression. The protrusions and the depressions of the guide member engaging portions 131 may respectively mate the protrusions and the depressions of the base engaging portion 121.

FIG. 7 shows a perspective view of a guide member of the guiding system according to one example of the present disclosure. The guide member 110 of the illustrated example in FIG. 7 has a guiding surface 112 configured to guide the wind turbine blade component 200 relative to the inner surface 130 of the blade shell 73. The guide member 110 of this example comprises a generally triangular-shaped section that extends the length along the longitudinal direction. Thus, an acute angle may be defined between the guiding surface 112 and the bottom portion 113. Accordingly, the guiding surface 112 may be inclined with respect the blade shell 73 when mounted. A connection portion 115 connects the bottom portion 113 to the guiding surface 112. The section of the guide member 110 of this figure is thus defined by the guiding surface 112, the bottom portion 113 and the connecting portion 115. This section extends the length along the longitudinal direction.

In this Figure, the guide member comprises an inner wall 116 extending along the vertical direction. This inner wall 116 extends between the guiding surface 112 and the bottom portion 113. The inner wall 116 of this example defines two open chambers, each of them at opposite sides along the width. The guide member 110 may comprise internal webs 151 outwardly extending from the inner wall 116 in a direction perpendicular to the inner wall 116. The internal webs of the examples divide the open chambers into depressions 111.

The bottom portion 113 may comprise an outer bottom portion surface 114 defining, at least, a portion of the outline or contour of the guide member 110. The outer bottom portion surface 114 may face an upper face 142 of the base 120 when the guide member is attached to the base.

The bottom portion 113 may comprise an inner bottom portion surface 117 opposite to the outer bottom portion surface 114.

The bottom portion 113 may be shaped so as to match at least a region of the base 120. Furthermore, protrusions of the base may at least partially fit the depressions 111 of the guide member 110.

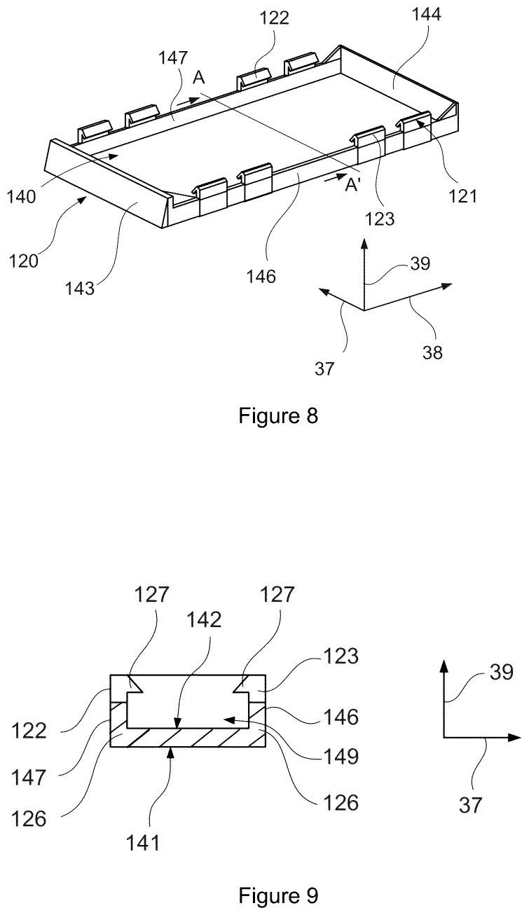

FIG. 8 shows a perspective view of a base 120 of the guiding system 100 according to one example of the present disclosure and FIG. 9 shows a cross-sectional view of the base 120 of FIG. 8 along the line AA′.

The base 120 may comprise a base body 140. The base body 140 may comprise a plate-like configuration. In some examples, the base body 140 may comprise a generally rectangular or square-shaped configuration seen from above. FIGS. 8-11 show examples of bases 120 having a generally rectangular configuration. However, in other examples, the base body 140 may comprise a differently shaped configuration.

The base body 140 may comprise a lower face 141 and an upper face 142. The upper face 142 may be configured to receive at least a portion of the guide member 110, such as the bottom portion 113. In some examples, the upper face 142 and the bottom portion 113 may comprise complementary shaped regions.

The base 120 of FIGS. 8-9 comprises a pair of lateral walls 143, 144 that may be arranged at the opposite sides of the lateral axis of base 120 that is substantially parallel to the spanwise direction 37 when the base is connected to the blade shell. The lateral walls 143, 144 are thus arranged opposite to each other along the longitudinal axis (substantially parallel to the chordwise direction 38 when the base is connected to the blade shell).

The lateral walls 143, 144 of FIGS. 8-9 protrude from the upper face 142 along the vertical direction (substantially parallel to the flapwise 39 direction when the base 120 is mounted on the blade shell 73. The lateral walls 143, 144 may help to retain the guide member such that the guide member 110 may be kept in place in the longitudinal axis. In some examples, the base 120 may be void of lateral walls or the shape or the number of lateral walls may vary. In some examples, the lateral walls may continuously extend along the width of the base 120. In other examples, the lateral walls may discontinuously extend along the width of the base 120. The lateral walls may thus be formed by lateral wall segments.

The lateral walls 143, 144 of FIGS. 8-9 comprise an outer and an inner surface. In this example, the outer surface of the lateral walls is tilted forward. This inclination may additionally help to guide the wind turbine blade component to the predetermined position

The base 120 of FIGS. 8-9 comprises a pair of longitudinal walls 146, 147. The longitudinal walls 146, 147 are arranged at the opposite sides of the longitudinal axis of base 120 that is substantially parallel to the chordwise direction 38 when the base 120 is mounted on the blade shell 73. The longitudinal walls 146, 147 are thus arranged opposite to each other along the lateral axis. The longitudinal walls 146, 147 protrude from the upper face 142, in such a way that the longitudinal walls 146, 147 substantially extend in the flapwise or vertical direction when the base 120 is mounted on the blade shell 73. The longitudinal walls 146, 147 may help to retain the guide member such that the guide member 110 may be kept in place related to the lateral axis. The longitudinal walls 146, 147 support the first protrusion and the second protrusion. In some examples, the base 120 may be void of longitudinal walls 146, 147 or the number of longitudinal walls 146, 147 may vary.

A lateral wall distance may be defined between the lateral walls 143, 144 along the longitudinal axis. A longitudinal wall distance may be defined between the longitudinal walls 146, 147 along the lateral axis.

At least one of the lateral wall distance and the longitudinal wall distance may define the dimensions of the bottom portion 113 when seen from above. In this way, the bottom portion 113 may fit the upper face 142.

In some examples, the base 120 comprises a first protrusion and a second protrusion arranged at opposite sides of a longitudinal axis of the base 120. The first protrusion and the second protrusion are thus arranged opposite to each other along the lateral axis. In some examples, the base 120 may comprise a plurality of first protrusions and/or a plurality of second protrusions. The protrusions may protrude from the longitudinal walls 147 and 146.

The examples of FIGS. 8-9 comprise a plurality of first protrusions 122 and a plurality of second protrusions 123. The first protrusions 122 are arranged at the longitudinal wall 147 and the second protrusions 123 are arranged at the longitudinal wall 146.

The first protrusion 122 and/or the second protrusion 123 may comprise a snap-fit cantilever having a cantilever arm 126 connected to an end hook 127, as depicted in FIGS. 8-9.

The protrusions 122, 123 of FIGS. 8-9 are configured to deform or bend about the longitudinal direction under a predetermined force. This bending movement causes the end hooks 127 to move outwards to allow the guide member 110 to be positioned on the base. After the application of the force the protrusions recover its initial position to attach the guide member 110 to the base 120. This way, the guide member 110 and the base 120 may be joined or brought together.

In this example, the end hook 127 may project into the corresponding depression 111 of the guide member 110 to form a snap-fit engagement. The guide member 110 and the base 120 may thus be joined together.

The first protrusion 122 and/or the second protrusion 123 may be configured to deform, under a predetermined force, in the lateral direction to remove the guide member 110 from the base 120. This way, the guide member 110 and the base 120 may become spaced apart from each other in an easy and simple way.

The first protrusion and/or the second protrusion that comprise a snap-fit cantilever may be deformed in the lateral direction during a removing operation, in such a way that the end hook 127 may move out of the corresponding depression 111 of the guide member 110.

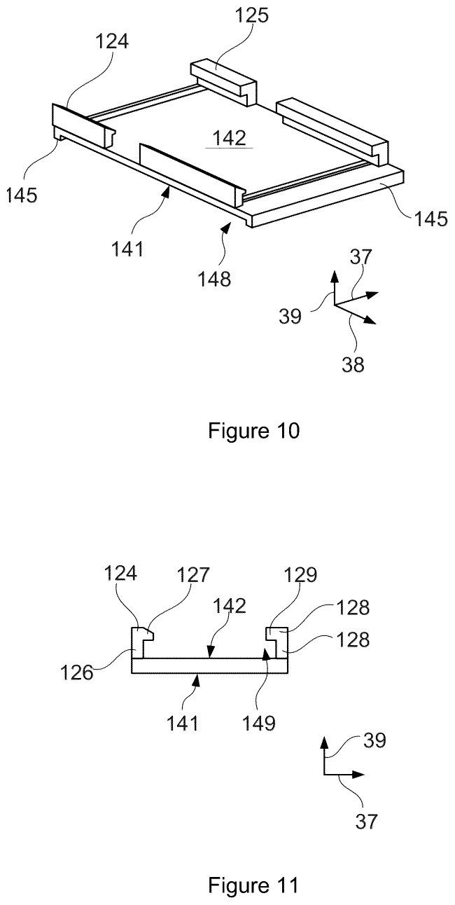

FIG. 10 shows a perspective view of a base 120 of the guiding system according to a further example of the present disclosure and FIG. 11 shows a front view of the base of FIG. 10. The base of FIGS. 10 and 11 are void of a lateral wall.

In the example of FIGS. 10-11, the base 120 has two ridges 145 protruding from the lower face 141. The ridges 145 substantially extend in the flapwise direction when the base 120 is mounted on the blade shell 73. The ridges 145 may abut on the inner surface 130 when the base 120 is mounted on the blade shell 73. A bonding space 148 may thus be defined between the ridges 145. This bonding space 148 may be filled with glue or adhesive to connect the base 120 to the inner surface 130. The number and/or shape of ridges 145 may vary.

In the example of FIGS. 10-11, the second protrusion 125 comprises an L-shaped retainer having a retainer arm 128 connected to a projection 129 to be inserted into a depression 111 of the guide member 110. The retainer arm 128 may be more rigid than the cantilever arm 126, in such a way that a greater force may be required to deform the L-shaped retainer in the lateral direction.

In some examples, the first protrusion and/or the second protrusion may comprise an L-shaped retainer.

The example of FIGS. 10-11 has a first protrusion 124 that comprises a snap-fit cantilever. The second protrusion 125 comprise an L-shaped retainer. In order to connect the guide member 110 and the base 120, the projection 129 of the second protrusion 125 may be inserted into the depression 111 of the guide member 110. Then, one edge of the bottom portion 113 of the guide member 110 (and the whole guide member 110) pivots about the L-shaped retainer so that the opposite edge of the bottom portion 113 is pressed against the end hook 127. This pressure causes the cantilever arm 126 to outwardly deform so as to allow the end hook 127 to be inserted into a corresponding depression 111 of the guide member 110. In this way, at least the bottom portion of the guide member 110 substantially fits the base cavity 149.

In other examples, instead of pivoting the guide member 110, the guide member 110 and the base 120 of FIGS. 10-11 may be positioned by sliding the guide member 110 relative to the base 120 in a longitudinal direction.

To remove the guide member 110 from the base 120 of the example of FIGS. 10-11, the guide member 110 may slide along a longitudinal direction. However, the guide member 110 may also be removed by applying a predetermined force to deform the first protrusion 124 and/or the second protrusion 125 in the lateral direction.

The first protrusion 122, 124 and/or the second protrusion 123, 125 may comprise an L-shaped profile. L-shaped profile may comprise an L-shaped longitudinal section. Examples of this L-shaped profile may comprise the snap-fit cantilever and/or the L-shaped retainer as disclosed herein.

In the examples where at least one of the first protrusion and the second protrusion comprises a L-shaped retainer, the guide member 110 may be attached to or removed from the base 120 by deforming the first protrusion and the second protrusion in the lateral direction or by a relative sliding between the guide member 110 and the base 120.

In the illustrated examples, the bottom portion 113 is supported by the base body 140 and removably retained by the end hook 127 and/or the projection 129.

A base cavity 149 may be defined by the base body 140, the first protrusion and the second protrusion. The base 120 which comprises the first protrusion and the second protrusion along with the base body 140, may comprise a substantially U-shaped cross-section. See, for instance, FIGS. 9 and 11. In a joined position of the guiding system 100, as shown for instance in FIGS. 5 and 6, the cross section of the bottom portion 113 substantially fits the cross section of the base cavity 149.

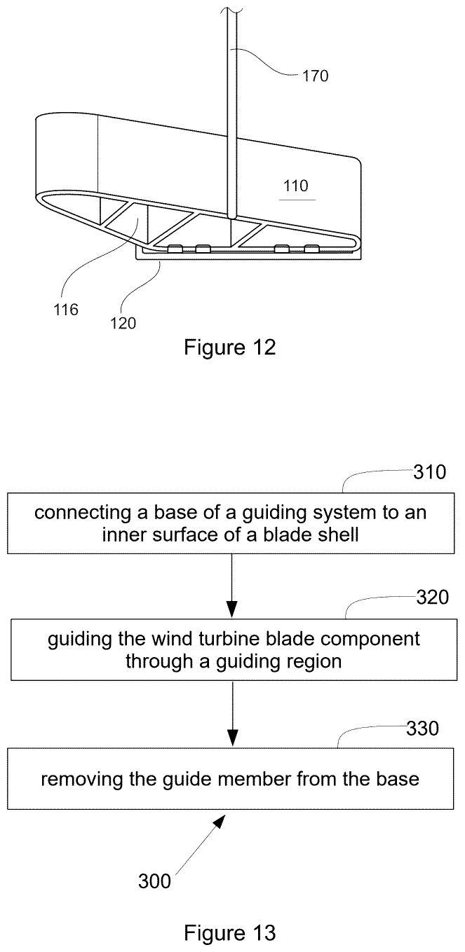

FIG. 12 shows a perspective view of a pulling member 170 attached to a guide member 110 according to one example. The pulling member 170 is configured to remove guide member 110 from the base 120. The pulling member 170 may comprise a wire, a rope, a chain, or the like.

In this example, one end of the pulling member 170 is secured into a hole arranged at the inner wall 116. However, other suitable connecting methods may be also used.

The staff may remotely remove the guide member 110 from the base 120 by pulling the pulling member 170. This may allow removing the guide member 110 of remote and/or inaccessible areas inside the blade cavity. Therefore, the possibility of staff injury may be reduced, and the manufacturing cycle time may be shortened. Furthermore, the number of recovered guide members may thus be increased. Recycling or reusing the guide members may consequently be enhanced.

A plurality of guide members 110 may be attached to the pulling member 170 such that the plurality of guide members 110 may be removed easily and remotely.

FIG. 13 is a block diagram of a method 300 for mounting a wind turbine blade component 200 within a wind turbine blade 7 according to an example of the present disclosure. A guiding system 100 as herein disclosed may be used for mounting the wind turbine blade component 200.

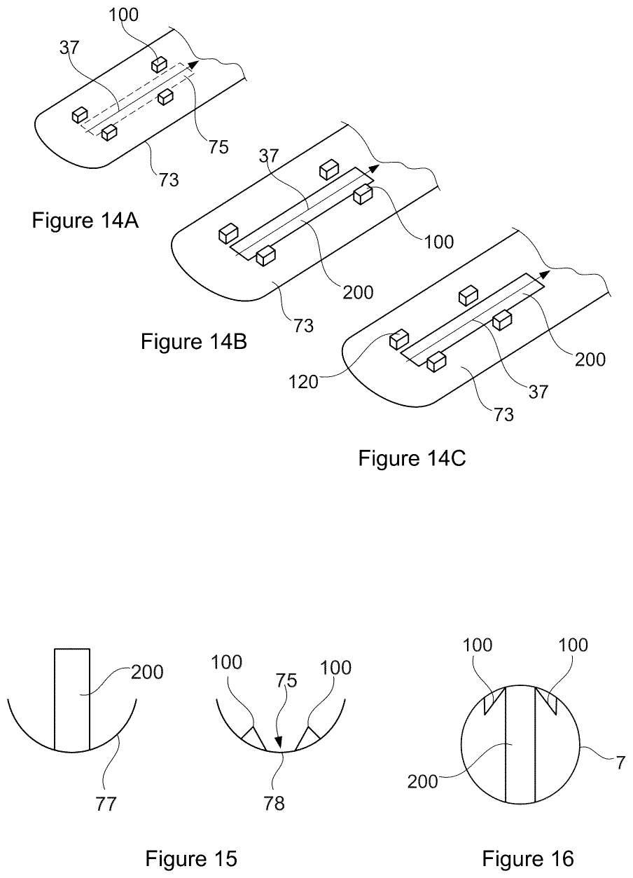

At block 310, connecting a base 120 of a guiding system 100 to an inner surface 130 of a blade shell 73 is represented. In some examples, the method 300 may comprise connecting the bases 120 of a plurality of guiding systems 100 to the inner surface of the blade shell. An example of this can be seen, for instance, in FIG. 14A that schematically illustrates a perspective view of a plurality of guiding systems 100 mounted on a blade shell 73 according to one example. The base 120 of each guiding system 100 has been fixedly attached to the inner surface 130 of the blade.

The number and location of the guiding systems 100 may vary, for instance, depending on the size and the number of the wind turbine blade component 200 to be mounted. In the example of FIG. 14A, the plurality of guiding systems 100 has been arranged on two rows along the spanwise direction. A guiding region 75 is defined in the blade shell 73 between the two rows of guiding systems 100.

The guiding region 75 may be a predetermined region of the inner surface 130 configured or intended to receive the wind turbine blade component 200. The wind turbine blade component 200 may be guided by the guide member 110 relative to the guiding region.

The arrangement of the guiding system 100 on the blade shell 73 may depend on the guiding region 75. The guiding system 100 may be arranged such that the longitudinal section of the guide member 110 taper towards the guiding region 75.

In some examples, connecting the base 120 of a guiding system 100 to an inner surface 130 of a blade shell 73 may comprise adhering the lower face 141 of the base 120 to the blade shell 73. Adhering or bonding the lower face 141 to the blade shell 73 may comprise filling the bonding space 148 with glue or adhesive. This way, the base 120 may be fixedly connected to the blade shell 73. Therefore, the base remains fixedly connected to the blade shell 73 after detaching the guide member 110 from the base 120. In further examples, the base 120 may be fixedly connected to the blade shell 73 using connectors, e.g. fasteners, rather than adhesive.

Referring back to FIG. 13, the method 300 further comprises guiding the wind turbine blade component 200 through the guiding region 75 inside the wind turbine blade 7 with the guide member 110 of the guiding system 100, as represented at block 320. As above mentioned, the guide member 110 is removably attached to the base 120.

The method may comprise guiding the wind turbine blade component 200 with the guide members 110 of the plurality of guiding systems 100 and removing the guide members 110 from the corresponding base 120 of the plurality of guiding systems.

FIG. 14B schematically illustrates a perspective view of a wind turbine blade component 200 guided by the plurality of guiding systems of FIG. 14A. As a plurality of guiding systems 100 are arranged in the spanwise direction with respect to the guiding region 75, the wind turbine blade component 200 and the guiding region 75 are arranged along the spanwise direction.

The guiding surface 112 of the guide member 110 may guide the wind turbine blade component 200 to the guiding region 75. Thus, the wind turbine blade component 200 may be correctly positioned relative to the blade shell 73.

In the example of FIG. 14B, the wind turbine blade component 200 is guided between the two rows of guiding systems 100. Although the wind turbine blade component is guided along the spanwise direction in FIG. 14B, the wind turbine blade component may be guided substantially along the flapwise direction.

In some examples of the method 300, the connecting the bases 120 of the plurality of guiding systems to the inner surface 130 of the blade shell 73 may comprise connecting a pair of bases 120 of the plurality of guiding systems at opposite sides of the guiding region 75.

According to one example, the connecting the bases 120 of the plurality of guiding systems to the inner surface 130 of the blade shell 73 may comprise connecting the base 120 of a set of guiding systems of the plurality of guiding systems in a zig-zag configuration along the guiding region 75.

In the method 300 and in the example of the FIG. 14B, the wind turbine blade component comprises a load carrying structure. However, the wind turbine blade component may be different in other examples.

Referring to FIG. 13, at block 330, removing the guide member 110 from the base 120 is represented. FIG. 14C schematically illustrates a perspective view of the plurality of guiding systems of FIG. 14B without the guide members 110 according to one example. The guide members 110 have been removed as disclosed herein.

Removing the guide member 110 may comprise applying a predetermined force substantially parallel to the spanwise direction. This force may cause the deformation of the first and/or second protrusions in the lateral direction.

In some examples, removing the guide member 110 may comprise sliding the guide member 110 in a direction substantially parallel to the chordwise direction.

The predetermined force to deform the protrusions in the lateral direction may be applied through the pulling member 170. In this way, the staff may pull the guide member 110 from outside the blade shell 73 or from a point away from the guiding system 100. The staff may be located for instance in the root area of the wind turbine blade 7.

FIG. 15 schematically illustrates a cross-sectional view of two wind turbine half blade shell parts 77, 78 before being joined together. FIG. 16 schematically illustrates a cross-sectional view of two wind turbine half blade shell parts 77, 78 after being joined together. The method 300, in this case, comprises attaching the wind turbine blade component 200 to the second half blade shell part 78.

In FIG. 15, the wind turbine blade component 200 is attached to a first half blade shell part 77 and the base 120 is connected to a second half blade shell part 78 or upwind side. In this example, the method 300 comprises bringing the first half blade shell part 77 and the second half blade shell part 78 together while guiding the wind turbine blade component 200 with the guide member 110 of the guiding system 100. The guide member 110 is configured to contact at least an edge of the wind turbine blade component 200 to guide the wind turbine blade component 200 to the guiding region 75. The guiding region 75 has been illustrated in FIG. 15 in the second half blade shell part 78. In this way, the wind turbine blade component 200 may be properly positioned in a predetermined location relative to the blade shell 73 after the wind turbine blade half shell parts 77, 78 are joined together. A suitable glue or adhesive may be used to bond the wind turbine blade component 200 and the first half blade shell part 77.

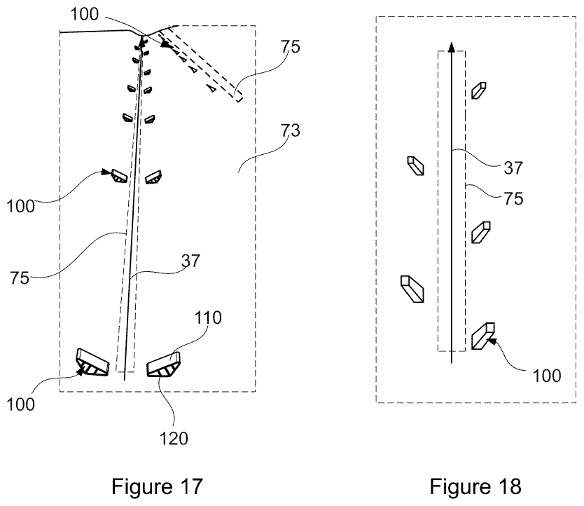

FIG. 17 schematically illustrates a plurality of guiding systems 100 mounted on a blade shell 73 according to one example. The pair of guide members 110 may be arranged such that the slanting guiding surfaces 112 may substantially define a V-shaped cross-section relative to the guiding region 75.

As can be seen in example of FIG. 17, the plurality of guiding systems is distributed along the spanwise direction. In FIG. 17 there are two guiding regions 75 because there are two wind turbine blade components to be guided. On the left side of FIG. 17, there are two rows of guiding systems. On the right side there is a single row of guiding systems, for guiding for instance a trailing edge shear web.

FIG. 18 schematically illustrates the plurality of guiding systems 100 mounted in a zig-zag configuration on a blade shell 73. The zig-zag configuration may allow reducing the number of guiding systems 100 to be installed on the blade shell 73.

According to an aspect, a wind turbine blade is disclosed. The wind turbine blade comprises a blade shell 73, a wind turbine blade component 200 and a base 120 of a guiding system connected to an inner surface of the blade shell. The base 120 is configured to be removably attached to a guide member 110 of the guiding system 100. The wind turbine blade component 200 may be mounted within the wind turbine blade 7 implementing a method 300 for mounting a wind turbine blade component 200 within the wind turbine blade 7 according to the present disclosure.

In examples, the wind turbine blade 7 may comprise a plurality of bases connected in a zig-zag configuration along a guiding region 75. The base of a set of guiding systems of a plurality of guiding systems 100 may be mounted in a zig-zag configuration at both sides of the guiding region 75 along the spanwise direction.

For reasons of completeness, various aspects of the present disclosure are set out in the following numbered clauses:

Clause 1: A guiding system (100) for a wind turbine blade component (200), the guiding system comprising:
a guide member (110) to guide the wind turbine blade component (200) relative to an inner surface (130) of a blade shell (73);
a base (120) removably attached to the guide member (110), wherein the base is to be connected to the inner surface (130) of the blade shell (73).

Clause 2: The guiding system (100) according to clause 1, wherein the base (120) comprises one or more base engaging portions (121) to engage a corresponding guide member engaging portion (131) for removably attaching the guide member to the base.

Clause 3: The guiding system (100) according to clause 2, wherein one of the base engaging portions (121) and the corresponding guide member engaging portion (131) comprises a snap-fit joint.

Clause 4: The guiding system (100) according to any of clauses 2-3, wherein one of the base engaging portion (121) and the corresponding guide member engaging portion (131) comprises a protrusion and the other one comprises a depression to mate the protrusion.

Clause 5: The guiding system (100) according to clause 4, wherein the base engaging portion (121) comprises a protrusion.

Clause 6: The guiding system (100) according to clause 5, wherein the base (120) comprises a first protrusion (122, 124) and a second protrusion (123, 125) arranged at opposite sides of a longitudinal axis of the base (120).

Clause 7: The guiding system (100) according to clause 6, wherein the first protrusion (122, 124) and/or the second protrusion (123, 125) comprises an L-shaped profile.

Clause 8: The guiding system (100) according to any of clauses 6-7, wherein the first protrusion (122, 124) comprises a snap-fit cantilever having a cantilever arm (126) connected to an end hook (127).

Clause 9: The guiding system (100) according to any of clauses 6-8, wherein the base (120) comprises a width extending along a lateral direction, the lateral direction being perpendicular to the longitudinal axis, and wherein the first protrusion (122, 124) is to deform under a predetermined force in the lateral direction to remove the guide member (110) from the base (120).

Clause 10: The guiding system (100) according to any of clauses 6-9, wherein the second protrusion (125) comprises an L-shaped retainer having a retainer arm (128) connected to a projection (129) to be inserted into a depression of the guide member.

Clause 11: The guiding system (100) according to any of clauses 6-9, wherein the second protrusion (123) comprises a snap-fit cantilever having a cantilever arm (126) connected to an end hook (127).

Clause 12: The guiding system (100) according to any of clauses 1-11, comprising a pulling member (170) attached to the guide member (110) to remove the guide member from the base (120).

Clause 13: The guiding system (100) according to any of clauses 1-12, wherein the wind turbine blade component (200) comprises a shear web (43, 44).

Clause 14: A method (300) for mounting a wind turbine blade component (200) within a wind turbine blade (7), comprising:
connecting (310) a base (120) of a guiding system (100) to an inner surface (130) of a blade shell (73);
guiding (320) the wind turbine blade component through a guiding region (75) inside the wind turbine blade with a guide member (110) of the guiding system, wherein the guide member is removably attached to the base; and
removing (330) the guide member from the base.

Clause 15: The method (300) according to clause 14, wherein the wind turbine blade component (200) is attached to a first half blade shell part (77) and the base (120) is connected to a second half blade shell part (78); the method comprises:
bringing the first half blade shell part (77) and the second half blade shell part (78) together while guiding the wind turbine blade component (200) with the guide member (110) of the guiding system (100); and
attaching the wind turbine blade component (200) to the second half blade shell part (78).

Clause 16: The method (300) according to any of clauses 14-15, comprises:
connecting the bases (120) of a plurality of guiding systems (100) to the inner surface (130) of the blade shell;
guiding the wind turbine blade component (200) with the guide members (110) of the plurality of guiding systems; and
removing the guide members (110) from the corresponding base (120) of the plurality of guiding systems.

Clause 17: The method (300) according to clause 16, wherein connecting the bases (120) of the plurality of guiding systems (100) to the inner surface (130) of the blade shell (73) comprises connecting a pair of bases of the plurality of guiding systems at opposite sides of the guiding region (75).

Clause 18: The method (300) according to clause 16, wherein connecting the bases (120) of the plurality of guiding systems (100) to the inner surface (130) of the blade shell (73) comprises connecting the base of a set of guiding systems of the plurality of guiding systems in a zig-zag configuration along the guiding region (75).

Clause 19: A wind turbine blade (7) comprising:
a blade shell (73);
a wind turbine blade component (200);
a base (120) of a guiding system (100) connected to an inner surface (130) of the blade shell, wherein the base is configured to be removably attached to a guide member (110) of the guiding system.

Clause 20: The wind turbine blade (7) according to clause 19, comprising:
a plurality of bases (120) connected in a zig-zag configuration along a guiding region (75).

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application. If reference signs related to drawings are placed in parentheses in a claim, they are solely for attempting to increase the intelligibility of the claim, and shall not be construed as limiting the scope of the claim.

1-15. (canceled)

16. A guiding system for a wind turbine blade component, the guiding system comprising:
a guide member configured to guide the wind turbine blade component relative to an inner surface of a blade shell; and
a base removably attached to the guide member, wherein the base is connected to the inner surface of the blade shell.

17. The guiding system of claim 16, wherein the base comprises one or more base engaging portions to engage a corresponding guide member engaging portion for removably attaching the guide member to the base.

18. The guiding system of claim 17, wherein at least one of the base engaging portions and the corresponding guide member engaging portion comprises a snap-fit joint.

19. The guiding system of claim 18, wherein at least one of the one or more base engaging portions and the corresponding guide member engaging portion comprises a protrusion and the other one comprises a corresponding depression to mate with the protrusion.

20. The guiding system of claim 19, wherein at least one of the one or more base engaging portions comprises the protrusion.

21. The guiding system of claim 20, wherein the base comprises a first protrusion and a second protrusion arranged at opposite sides of a longitudinal axis of the base.

22. The guiding system of claim 21, wherein at least one of the first protrusion or the second protrusion comprises an L-shaped profile.

23. The guiding system of claim 21, wherein the first protrusion comprises a snap-fit cantilever having a cantilever arm connected to an end hook.

24. The guiding system of claim 21, wherein the base comprises a width extending along a lateral direction, the lateral direction being perpendicular to the longitudinal axis, and wherein the first protrusion is to deform under a predetermined force in the lateral direction to remove the guide member from the base.

25. The guiding system of claim 21, wherein the second protrusion comprises an L-shaped retainer having a retainer arm connected to a projection to be inserted into a depression of the guide member.

26. The guiding system of claim 16, wherein the wind turbine blade component comprises a shear web.

27. A method for mounting a wind turbine blade component within a wind turbine blade, the method comprising:
connecting a base of a guiding system to an inner surface of a blade shell of the wind turbine blade;
guiding the wind turbine blade component through a guiding region inside the wind turbine blade with a guide member of the guiding system, wherein the guide member is removably attached to the base; and
removing the guide member from the base.

28. The method of claim 27, wherein the wind turbine blade component is attached to a first half blade shell part and the base is connected to a second half blade shell part, the method further comprising:
bringing the first half blade shell part and the second half blade shell part together while guiding the wind turbine blade component with the guide member of the guiding system; and
attaching the wind turbine blade component to the second half blade shell part.

29. The method of claim 27, further comprising:
connecting a plurality of bases of a plurality of guiding systems to the inner surface of the blade shell;
guiding the wind turbine blade component with a plurality of guide members of the plurality of guiding systems; and
removing the plurality of guide members from the corresponding plurality of bases of the plurality of guiding systems.

30. A wind turbine blade, comprising:
a blade shell;
a wind turbine blade component;
a guiding system for the wind turbine blade component, the guiding system comprising:
a guide member configured to guide the wind turbine blade component relative to an inner surface of the blade shell; and
a base removably attached to the guide member, wherein the base is connected to the inner surface of the blade shell.
